(19) United States
(12) Patent Application Publication
(10) Pub. No.: US 2001/0047589 A1
(43) Pub. Date: Dec. 6, 2001

(54) APPARATUS FOR BRINGING LEADS TOGETHER

(76) Inventor: ALOIS CONTE, EBIKON (CH)

Correspondence Address: KLAUS P STOFFEL, COHEN PONTANI LIEBERMAN & PAVANE, SUITE 1210, 551 FIFTH AVENUE, NEW YORK, NY, 10176

(21) Appl. No.: 09/386,606

(22) Filed: Aug. 31, 1999

(30) Foreign Application Priority Data
Aug. 31, 1998 (EP) 98810861.9

(51) Int. Cl. H01R 43/04; B23P 19/00

(52) U.S. Cl. 29/857; 29/861; 29/33 M; 29/761

(57) ABSTRACT

A gripper unit including a mounting bracket, a housing with a rotatable carrier and a height adjuster having a cylinder unit and guides, which are connected at the other end with the housing. The carrier is rotatable about a first axis by a first drive. Arranged at the carrier are a first gripper module with a first gripper and a second gripper module with a second gripper. The grippers can be spread apart or spread out by gripper drives. The second gripper module is rotatable about a second axis by a second drive. By this gripper unit, leads are brought together by rotary movements in order to be subsequently connected together in common with a contact by crimping technique.

### BACKGROUND OF THE INVENTION

1. Background of the Invention

The invention relates to apparatus for and a method of bringing leads together for production of a crimp connection, wherein at least two leads are brought together by means of a gripper unit in order to be subsequently connected in common with a contact by crimping technique.

2. Discussion of the Prior Art

In the case of a crimp connection the end of a lead is connected with a common contact in a mechanically positive manner. The contact has, for example, a first double strap for an insulation crimp and a second double strap for a wire crimp. Before the actual crimping process, the lead is inserted into the contact so that the end of the lead insulation lies in the first double strap and the portion of the lead stripped of insulation lies in the second double strap. Then a crimping die producing the insulation crimp and a crimping die producing the wire crimp are lowered, wherein the crimping zone of the contact is pressed against a bed constructed as an anvil. The first double strap with the lead stripped of insulation is pressed by the crimping die for the wire crimp and the second double strap with the lead insulation is pressed by the crimping die for the insulation crimp. It is also feasible to produce crimp connections with contacts which provide penetration contacting, in which, for example, contact spikes pierce the lead insulation during the crimping process and penetrate into the wire of the lead.

Crimp connections are produced in mass in automatic cable-making equipment, which, for example, connect a contact to one lead end by means of a crimp connection, then cut down the lead to the desired length and connect a contact to the other lead end by means of a crimp connection. The processing stations for the individual working procedures such as cutting, insulation stripping, feeding, crimping, etc., are mostly arranged centrally, wherein grippers are provided, which can execute pivot movements, rotary movements, linear movements, etc., for handling the leads or lead ends.

In the case of a double crimp connection, first ends of two leads are brought together and connected in a mechanically positive manner with a contact. The other end of each lead can be connected to a contact of the same or different mode of construction. The first ends of the leads are, for example, cut, stripped of insulation and transferred to a double gripper, wherein, due to the handling or processing, the leads run approximately parallel at a certain spacing from one another. The double gripper, which is, for example, equipped with two grippers, brings the leads or the lead ends together by a defined movement sequence. The leads or lead ends brought together are then taken over by a further gripper, which feeds the lead ends, for example by a pivot arm movement, to a contact positioned in a crimping press of the production equipment. The production of the crimp connection then follows as described further above, wherein the ends of the leads, which have been brought together, are simultaneously connected in a mechanically positive manner with the same contact.

Previously, double grippers have been used, which bring the lead ends together by linear movement sequences. The former double grippers do indeed fulfill their purpose, but due to the mode of movement and the technology associated therewith they are disadvantageously built in a relatively voluminous and bulky manner.

### SUMMARY OF THE INVENTION

Accordingly, it is an object of the present invention to provide a method and apparatus which brings leads together for producing a crimp connection which makes it possible to have compactly constructed cable making equipment.

Pursuant to this object, and others which will become apparent hereafter, one aspect of the present invention resides in a method for bringing leads together for production of a crimp connection in which at least two leads are brought together by at least one rotary movement of a gripper unit.

Another aspect of the invention resides in an apparatus for bringing leads together, which apparatus comprising a gripper unit having at least two rotatable grippers which bring the leads together by at least one rotary movement of the grippers.

In another embodiment of the invention gripper modules are arranged at a carrier with gripper drives for actuating the grippers. At least one gripper module is drivable by a drive so as to rotate about a second axis.

In still another embodiment of the invention the carrier is driven by a drive so as to be rotatable by a first axis.

The advantages achieved by the invention are essentially to be seen in that with the gripper unit according to the invention and by the movement sequence in accordance with the invention in the handling and processing region of production equipment more space is generally available and that due to the compact mode of construction of the double gripper and the arrangement of the grippers the feed of the leads and guidance away are possible just by means of a pivot arm movement, which is easy so perform, of the gripper bringing the leads together and taking them away.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

FIG. 1 shows a gripper unit according to the invention with grippers illustrated in the basic setting;

FIG. 2 shows the gripper unit after take over of a first lead;

FIG. 3 shows the gripper unit after take over of a second lead;

FIG. 4 shows the gripper unit after a first rotary movement;

FIG. 5 shows the gripper unit after a second rotary movement; and

FIG. 6 shows the take over of the leads, which have been brought together, by a further gripper module.

### DETAILED DESCRIPTION OF THE PREFERRED EMBODIMENTS

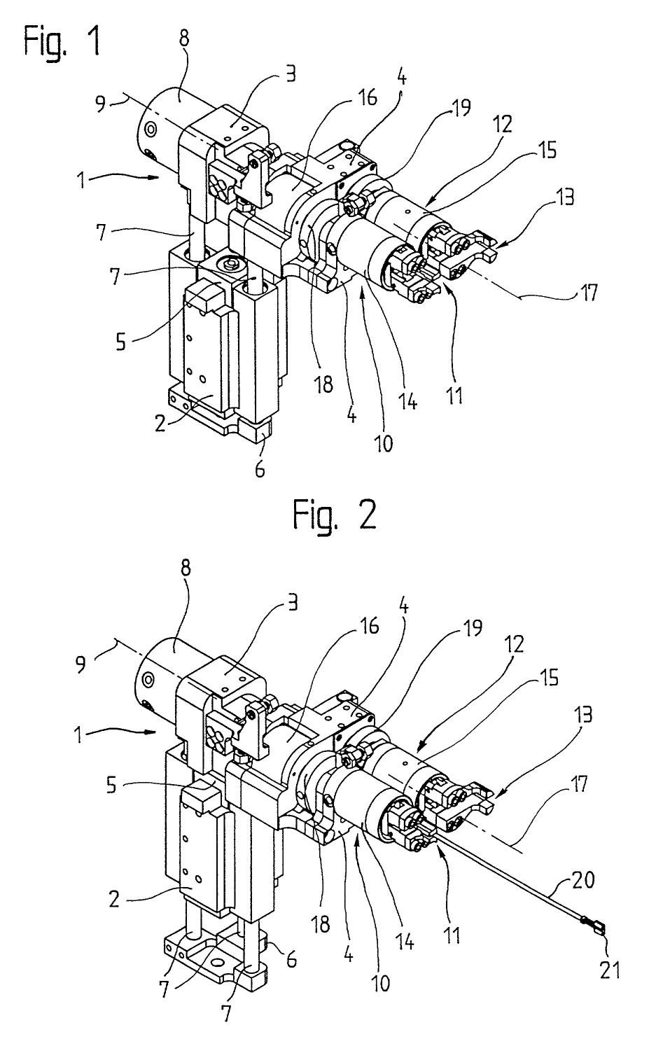

In FIGS. 1 to 6, a gripper unit consists of a mounting bracket 2, a housing 3 with a rotatable carrier 4 and a height adjuster consisting of a cylinder unit 5 and guides 7, which are connected at one end to a base plate 6 and are connected at the other end with the housing 3. The cylinder unit 5, which, for example, consists of three cylinders, enables adaptation to different lead diameters by means of adjustment in height of the housing 3 relative to the mounting bracket 2. The carrier 4 is rotatable about a first axis 9 by means of a first drive 8. Arranged at the carrier 4 are a first gripper module 10 with a first gripper 11 and a second gripper module 12 with a second gripper 13, which is, for example, L-shaped. The first gripper 11 can be spread apart or spread out by means of a first gripper drive 14. The second gripper 13 can be spread apart or spread out by means of a second gripper drive 15. The second gripper module 12 is rotatable about a second axis 17 by means of a second drive 16. The second drive 16 drives a first gearwheel 18, which stands in engagement with a second gearwheel 19, wherein the second gearwheel 19 is connected with the second gripper module 12.

The drives 8, 14, 15 and 16 or the cylinder unit 5 of the gripper unit 1 are pneumatic drives. Other forms of drive, such as for example electric motors or linear motors, are also possible instead of the cylinder unit 5.

FIG. 1 shows the grippers 11 and 13 in the basic setting, in which the grippers 11, 13 are spread out. The L-shaped second gripper 13 is rotated outwardly. The gripper unit 1 is driven up by means of the cylinder unit 5. This height adjustment is necessary for, for example, the cable removal subsequent to the crimping process.

FIG. 2 shows the gripper unit 1 in the basic setting in which the gripper unit 1 is driven down and the second gripper 13 is spread. The first gripper 11 has already taken over a first lead 20 from, for example, a gripper, which is not illustrated, arranged at a pivot arm. The end of the lead 20 at the gripper side can, for example, be stripped of insulation, wherein the lead 20 is held at the insulation by the first gripper 11. The other end of the lead 20 is connected with a first contact 21, for example, by crimping technique.

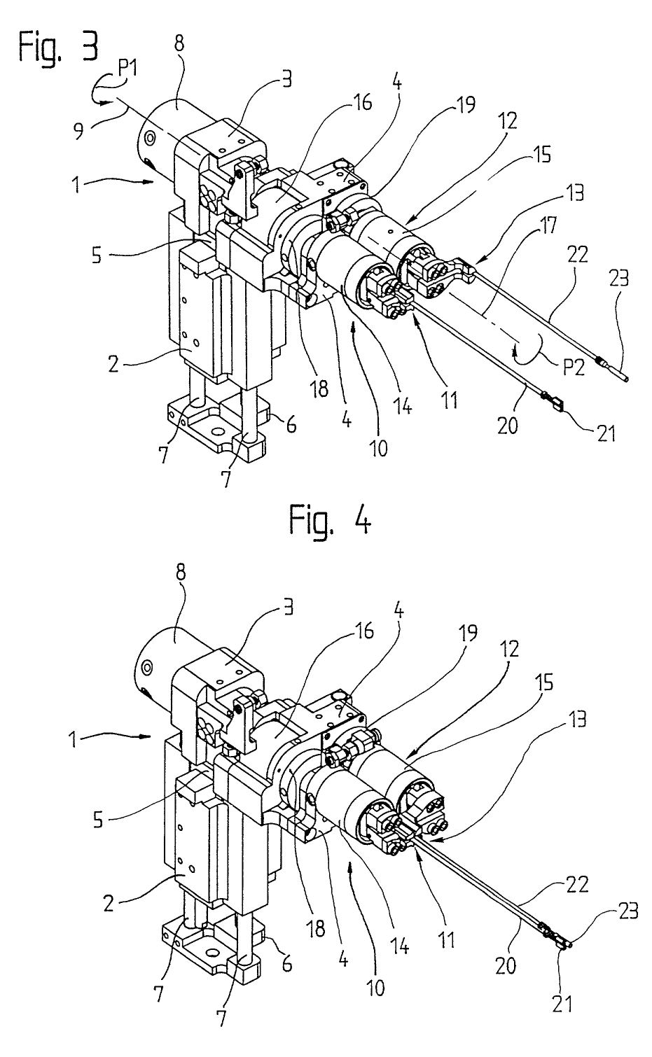

In FIG. 3 the second gripper has already taken over a second lead 22, for example from a gripper, which is not illustrated, arranged at a pivot arm. The end of the second lead 22 at the gripper side can, for example, be stripped of insulation, wherein the lead 22 is held at the insulation by the second gripper 13. The other end of the lead 22 is connected with a second contact 23 by, for example, crimping technique. Subsequently, the second gripper module 12 is turned through 180° in the second arrow direction P2 about the second axis 17 by means of the second drive 16. The first gripper 11 and the second gripper 13 or the first lead 20 and the second lead 22 now lie closely beside one another.

If the leads 20, 22 brought together are used for a horizontal double crimp connection, the process of bringing together the leads 20, 22 used for crimping purposes is concluded. The leads 20, 22 are taken over by a further gripper module, which feeds the leads 20, 22 to a contact positioned in a crimping press of the production equipment.

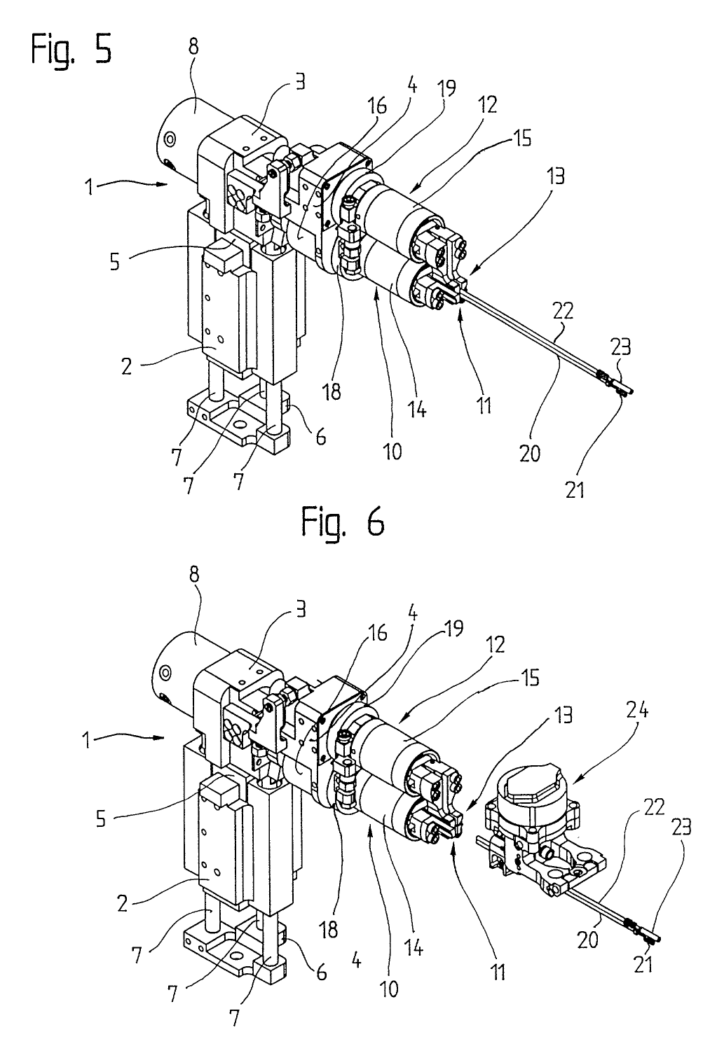

If the leads 20, 22 brought together are used for a vertical double crimp connection, the process of bringing together the leads 20, 22 used for crimping purposes is continued, in that the carrier 4 is rotated through 90°, for example in the first arrow direction P1, about the first axis 9 by means of the first drive 8, wherein the 180° rotation of the second gripper module 12 is, for example, carried out simultaneously with the 90° rotation of the carrier 4. The carrier 4 can also, for the purpose of better cable separation, be rotated in a direction opposite to the first arrow direction P1. As shown in FIG. 5, the first gripper 11 and the second gripper 13 or the first lead 20 and the second lead 22 now lie closely one above the other. Thus, the process of bringing together the leads 20, 22 used for crimping purposes is concluded. The leads 20, 22 are, as shown in FIG. 6, removed from the further gripper module 24, which after a withdrawing movement feeds the leads 20, 22 by a pivot movement to a contact positioned in a crimping press of the production equipment.

The embodiment relates to the bringing together of two leads 20, 22 for a double crimp connection. It goes without saying that the gripper unit 1 can be constructed for bringing together more than two leads and the brought-together leads are used for a multiple crimp connection.

The invention is not limited by the embodiments described above which are presented as examples only but can be modified in various ways within the scope of protection defined by the appended patent claims.

I claim:

1. A method for bringing leads together for production of a crimp connection, comprising the step of bringing together at least two leads using a gripper unit for subsequent connection in common with a contact by a crimping technique, the leads being brought together by at least one rotary movement of the gripper unit.

2. A method according to claim 1, including taking over the leads with grippers of the gripper unit and bringing the leads together by rotating the grippers of the gripper unit.

3. A method according to claim 2, wherein a first one of the grippers takes over a first lead and a second one of the grippers takes over a second lead, the second gripper bringing the leads into a position adjacent one another by a subsequent rotational movement, the leads being brought together for a horizontal double crimp connection.

4. A method according to claim 2, wherein a first one of the grippers takes over a first lead and a second one of the grippers takes over a second lead, the method including bringing the leads together to lie above one another by a rotational movement of the second gripper and a further rotational movement of both the grippers, the leads being brought together for a vertical double crimp connection.

5. An apparatus for bringing leads together for production of a crimp connection, comprising a gripper unit with at least two rotatable grippers configured to bring the leads together by at least one rotary movement.

6. An apparatus according to claim 5, and further comprising a carrier and gripper modules arranged at the carrier, the gripper modules including gripper drives for actuation of the grippers, and still further comprising means for rotating at least one gripper module about a second axis.

7. An apparatus according to claim 6, and further comprising drive means for rotating the carrier about a first axis.

8. An apparatus according to claim 5, and further comprising linear drive means for vertically adjusting the gripper unit.
